(19) United States
(12) Patent Application Publication
(10) Pub. No.: US 2026/0368449 A1
(43) Pub. Date: Nov. 19, 2026

(54) COMPUTER PROGRAM, INFORMATION PROCESSING METHOD, INFORMATION PROCESSING DEVICE, AND INFORMATION PROCESSING SYSTEM

(71) Applicant: Tokyo Electron Limited, Tokyo (JP)

(72) Inventor: Motohiro OKAYA, Sapporo City (JP)

(73) Assignee: Tokyo Electron Limited, Tokyo (JP)

(21) Appl. No.: 19/732,588

(22) Filed: Jul. 7, 2026

Related U.S. Application Data
(63) Continuation of application No. PCT/JP2025/000136, filed on Jan. 7, 2025.

(30) Foreign Application Priority Data
Jan. 15, 2024 (JP) 2024-004027

(51) Int. Cl. G06F 40/40

(52) U.S. Cl. CPC G06F 40/40

(57) ABSTRACT

The present disclosure provides a non-transitory computer-readable medium storing computer executable instructions which, when executed by a computer, cause the computer to execute a process including acquiring, from a history database storing information related to a history of handling an event occurring in a device, information indicating that handling of the event is not completed; generating, using a language model, a question sentence in a natural language related to the acquired information indicating that the handling of the event is not completed; outputting the generated question sentence; acquiring an answer to the question sentence; and storing information related to the acquired answer in an answer database.

### CROSS-REFERENCE TO RELATED APPLICATIONS

This application is a bypass continuation application of international application No. PCT/JP2025/000136 having an international filing date of Jan. 7, 2025 and designating the United States, the international application being based upon and claiming the benefit of priority from Japanese Patent Application No. 2024-004027, filed on Jan. 15, 2024, the entire contents of which are incorporated herein by reference.

### TECHNICAL FIELD

The present disclosure relates to a computer program, an information processing method, an information processing device, and an information processing system.

### BACKGROUND

PTL 1 describes a bot system that uses an avatar to interact with a user in a natural language and coordinates a team of independent helper bots. The helper bots can perform various tasks and provide content by utilizing a digital library architecture, such as ranking content based on a user profile and customizing a search function to suit a user preference.

### CITATION LIST

### Patent Documents

PTL 1: US2016/0044380.

### SUMMARY

In accordance with an exemplary implementation of the present disclosure, a non-transitory computer-readable medium stores computer executable instructions which, when executed by a computer, cause the computer to execute a process including acquiring, from a history database storing information related to a history of handling an event occurring in a device, information indicating that handling of the event is not completed; generating, using a language model, a question sentence in a natural language related to the acquired information indicating that the handling of the event is not completed; outputting the generated question sentence; acquiring an answer to the question sentence; and storing information related to the acquired answer in an answer database.

According to another exemplary implementation of the present disclosure, an information processing device includes processing circuitry configured to: acquire, from a history database storing information related to a history of handling an event occurring in a device, information indicating that handling of the event is not completed; generate, using a language model, a question sentence in a natural language related to the acquired information indicating that the handling of the event is not completed; output the generated question sentence; acquire an answer to the question sentence; and store information related to the acquired answer in an answer database.

### BRIEF DESCRIPTION OF DRAWINGS

FIG. 1 is a schematic diagram illustrating an overview of an information processing system.

FIG. 2 is a block diagram illustrating a configuration example of an information processing device.

FIG. 3 is a schematic diagram illustrating an example of a trouble handling database.

FIG. 4 is a block diagram illustrating a configuration example of a trouble history recording device.

FIG. 5 is a schematic diagram illustrating an example of trouble history information stored in a trouble history DB.

FIG. 6 is a flowchart illustrating an example of a procedure of processing executed by the information processing device.

FIG. 7 is a schematic diagram illustrating an example of information input to a large language model and information output by the large language model.

FIG. 8 is a schematic diagram illustrating an example of information input to the large language model and information output by the large language model.

FIG. 9 is a schematic diagram illustrating an example of information input to the large language model and information output by the large language model.

FIG. 10 is a schematic diagram illustrating an example of information input to the large language model and information output by the large language model.

FIG. 11 is a schematic diagram illustrating an example of information input to the large language model and information output by the large language model.

FIG. 12 is a schematic diagram illustrating an example of information displayed by a terminal device.

### DETAILED DESCRIPTION

Hereinafter, specific examples of an information processing system according to the present disclosure will be described with reference to the drawings. The present disclosure is not limited to these examples; it is defined by the claims and is intended to include all modifications within the meaning and scope equivalent to the claims.

### System Overview

An information processing system stores, in a database, information related to histories of events occurring in various devices such as a substrate processing device or a transfer device. An event occurring in a device may include various events such as an abnormality, a failure, maintenance, a setting change, a component replacement, or a function addition in the device. The information related to a history of an event occurring in a device may include various kinds of information, such as the occurrence of an event such as an abnormality or a failure in the device, a countermeasure taken by a technician or the like in response to the occurrence of an event (trouble handling by an engineer or the like), or a cause investigated for the event. The information related to a history of an event occurring in a device may also include information such as a perspective of one or more technicians or the like regarding an event occurring in a device, discussions conducted among a plurality of technicians, or a question and an answer related to an event. The information processing system reorganizes these various kinds of information stored in a database and creates a new database by supplementing insufficient information, thereby supporting the utilization of knowledge of past technicians. Hereinafter, an example of a system that handles a trouble, such as an abnormality or a failure occurring in a substrate processing device or the like, as an event occurring in the device will be described.

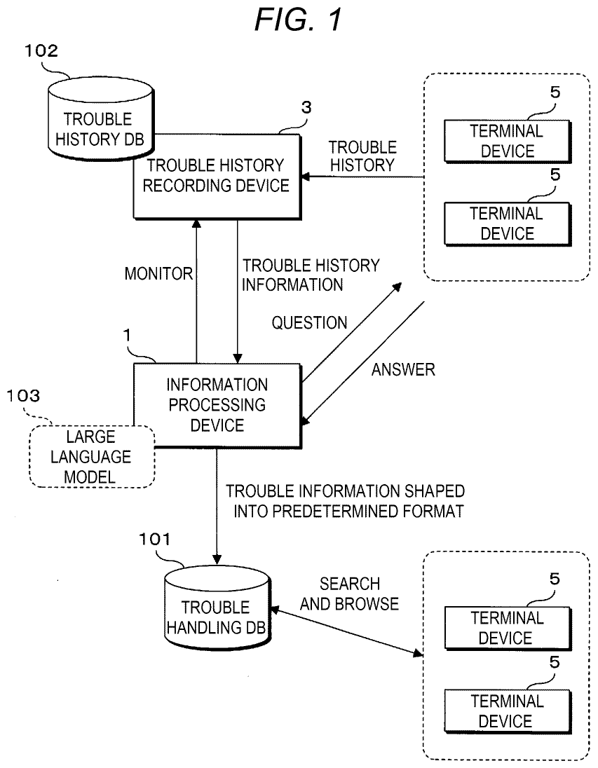

FIG. 1 is a schematic diagram illustrating an overview of an information processing system. The information processing system includes an information processing device 1, a trouble history recording device 3, a terminal device 5, and the like. The terminal device 5 is a device used by a user who uses or manages a device such as a substrate processing device or a transfer device. Various general-purpose devices, such as a personal computer, a smartphone, or a tablet-type terminal device, can be used as the terminal device 5. When a trouble such as an abnormality or a failure occurs in a target device, a user who handles the trouble inputs, into the terminal device 5, information related to a history of handling the trouble occurring in the device, such as details of the trouble occurring in the target device and details of a measure taken for the trouble. The information related to the history of handling the trouble input by the user is transmitted from the terminal device 5 to the trouble history recording device 3. For example, the user inputs information each time the user handles a trouble of a device, and the terminal device 5 transmits the information to the trouble history recording device 3 each time information is received from the user. The user may input information multiple times for one trouble, and the input and transmission of the information may be repeated until the trouble is resolved. Further, a plurality of users may input information for one trouble.

The trouble history recording device 3 is a device that records, in a trouble history DB (database) 102, information related to a history of handling troubles occurring in various devices such as a substrate processing device or a transfer device. The trouble history recording device 3 acquires information related to a trouble transmitted from the terminal device 5 and stores the acquired information in the trouble history DB 102, together with information such as the date and time when a trouble occurred, the date and time when the trouble was handled, identification information of a device in which the trouble occurred, identification information for identifying the trouble, and identification information of a user who handled the trouble. The trouble history recording device 3 can acquire information multiple times for one trouble and store the information in the trouble history DB 102, and stores a plurality of pieces of information related to one trouble in association with one another so that the plurality of pieces of information can be traced in a time-series order as a history of handling the trouble. That is, the information related to a history of handling one trouble may include a plurality of pieces of information spanning from the occurrence of the trouble to the resolution of the trouble.

The information processing device 1 executes processing of monitoring the recording of information related to a history of handling a trouble (hereinafter referred to as trouble history information) by the trouble history recording device 3. The information processing device 1 periodically examines the trouble history information recorded in the trouble history DB 102 of the trouble history recording device 3 and searches for a case in which there is no recording of a history of resolving a trouble after the trouble has occurred and a predetermined period (for example, one month or more) has elapsed since the last input of information related to a history of the case. When such incomplete trouble history information is stored in the trouble history DB 102, the information processing device 1 transmits a question message, asking one or more users (for example, the terminal devices 5 used by the users) related to the trouble about a subsequent handling history. The information processing device 1 receives an answer message from the user in response to the question message and completes the information related to a history of the incomplete trouble based on the received answer message. The exchange of messages between the information processing device 1 and the user may be repeated a plurality of times until the trouble history information is sufficiently obtained.

Based on the trouble history information stored in the trouble history DB 102 of the trouble history recording device 3 and the information obtained through the message exchange performed between the information processing device 1 and the user, the information processing device 1 converts information related to a trouble into information in a predetermined format and stores the converted information related to the trouble in the trouble handling DB 101 in the predetermined format. When the trouble history information stored in the trouble history DB 102 of the trouble history recording device 3 has been collected until the handling of a trouble is completed, the information processing device 1 acquires the information stored in the trouble history DB 102 of the trouble history recording device 3, converts the information into a predetermined format, and stores the information in the trouble handling DB 101 without exchanging messages with a user.

Information related to handling of a trouble stored in the trouble handling DB 101 is made available to a plurality of users. A user can search the information stored in the trouble handling DB 101 via the terminal device 5 under various conditions and browse desired information. A user who can search and browse the information stored in the trouble handling DB 101 may include not only a user who has handled a trouble of a device such as a substrate processing device or a transfer device, but also various users who seek knowledge of how to handle a trouble in such a device.

The information processing device 1 uses a trained large language model (LLM) 103 when exchanging a message with a user and when shaping information related to a trouble into a predetermined format. The information processing device 1 inputs the incomplete trouble history information stored in the trouble history DB 102 into the large language model 103 and causes the large language model 103 to generate a question sentence in the natural language that asks a user about a status related to a trouble. Based on the question sentence generated by the large language model 103, the information processing device 1 transmits a question message to the terminal device 5 of one or more users who handled the trouble and obtains an answer message from the user. The answer message from a user may be, for example, a message written in the natural language, information indicating which option has been selected, or a message of any other form. The information processing device 1 inputs the answer message of a user into the large language model 103 to determine whether sufficient information has been obtained, and when sufficient information has not been obtained, the information processing device 1 generates an additional question sentence and repeats the message exchange with the user.

When sufficient information has been obtained, the information processing device 1 supplies, to the large language model 103, the trouble history information acquired from the trouble history DB 102 and the information acquired through the message exchange with the user, and supplies a command for shaping the information into a predetermined format. In the information processing system, the information stored in the trouble history DB 102 and the information acquired through the message exchange with the user is, or includes information in the natural language. The large language model 103 receives the information expressed in the natural language as an input and shapes the information into a designated predetermined format;, the large language model 103 shapes the information into a format suitable for storage in a database and outputs the shaped information in the predetermined format. The information processing device 1 acquires the information output from the large language model 103 and stores, in the trouble handling DB 101, the information in the predetermined format shaped by the large language model 103.

### Device Configuration

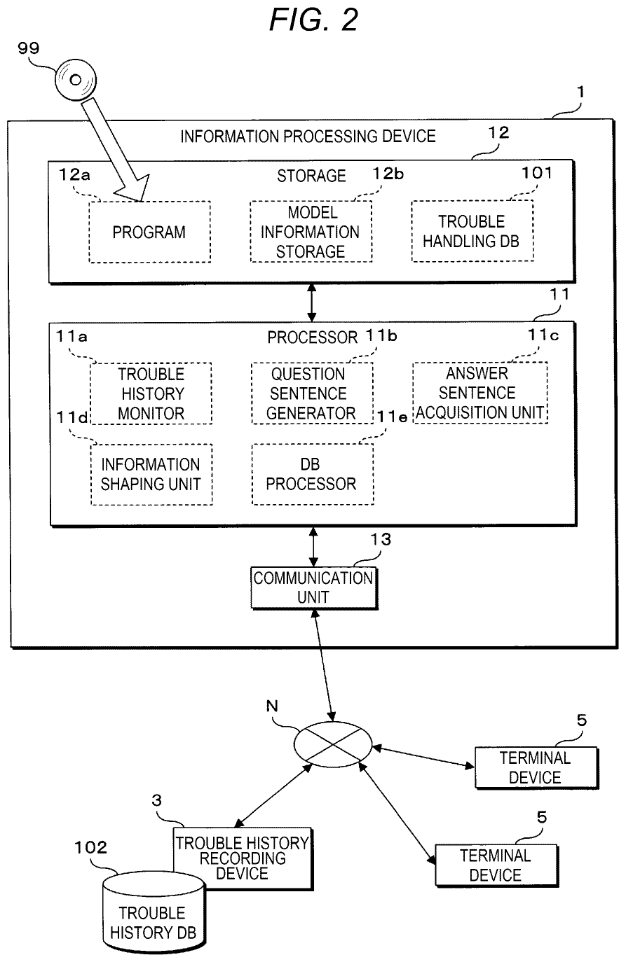

FIG. 2 is a block diagram illustrating a configuration example of the information processing device 1. The information processing device 1 can be implemented by installing a predetermined application program or the like in a general-purpose information processing device such as a personal computer or a server computer. The information processing device 1 includes a processor 11, a storage 12, a communication unit 13, and the like. An example will be described in which the processing is performed by one information processing device 1. However, the processing of the information processing device 1 may be distributed and performed by a plurality of devices. In exemplary configurations, processor 11 may include circuitry or processing circuitry, which includes general purpose processors, special purpose processors, integrated circuits, ASICs (“Application Specific Integrated Circuits”), FPGAs (“Field-Programmable Gate Arrays”), and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The processor 11 is configured using an arithmetic processing device such as a central processing unit (CPU), a micro-processing unit (MPU), a graphics processing unit (GPU), or a quantum processor, together with a read only memory (ROM), a random access memory (RAM), and the like. By reading and executing a program 12a stored in the storage 12, the processor 11 executes various kinds of processing such as processing of monitoring recording of information by the trouble history recording device 3, processing of exchanging a message with a user, and processing of shaping the obtained information into a predetermined format and storing the shaped information in the trouble handling DB 101.

The storage 12 is configured using, for example, a large-capacity storage device such as a hard disk or a solid state drive (SSD). The storage 12 stores various types of programs to be executed by the processor 11 and various types of data used in the processing performed by the processor 11. The storage 12 stores the program 12a to be executed by the processor 11. The storage 12 includes a model information storage 12b that stores information related to a trained model used for processing executed by the information processing device 1. Further, the storage 12 includes the trouble handling DB 101 that stores information related to handling of a trouble occurring in a device such as a substrate processing device or a transfer device.

The program (computer program, program product) 12a is provided in a form recorded on a recording medium 99 such as a memory card or an optical disc. The recording medium 99 is a non-transitory, computer-readable recording medium that stores the program 12a in a non-transitory manner; examples of the recording medium 99 include a magnetic recording medium, an optical recording medium, a magneto-optical recording medium, and a semiconductor memory, and the recording medium 99 does not encompass a transitory propagating signal per se. The information processing device 1 reads the program 12a from the recording medium 99 and stores the program 12a in the storage 12. Alternatively, for example, the program 12a may be written into the storage 12 during a manufacturing stage of the information processing device 1. As another example, the information processing device 1 may acquire the program 12a distributed by a remote server device or the like through communication. As still another example, the program 12a may be written into the storage 12 of the information processing device 1 after a writing device reads data recorded on the recording medium 99. The program 12a may be provided by being distributed through a network or may be provided in the form recorded on the recording medium 99.

The model information storage 12b stores information related to a trained model on which machine learning has been performed in advance. The information related to the trained model may include, for example, information indicating a configuration of the trained model and information such as values of internal parameters determined by machine learning. The model information storage 12b stores information related to the large language model 103 for exchanging a message in the natural language with a user and shaping information into a predetermined format. The information processing device 1 stores the information related to the trained model, and the information processing device 1 executes processing based on the trained model. However, the present disclosure is not limited thereto. The information related to the trained model may be stored in a device different from the information processing device 1, the different device may execute processing based on the trained model, and the information processing device 1 may acquire a processing result from the different device. Further, the machine learning processing for the model may be executed by the information processing device 1 or by a device different from the information processing device 1.

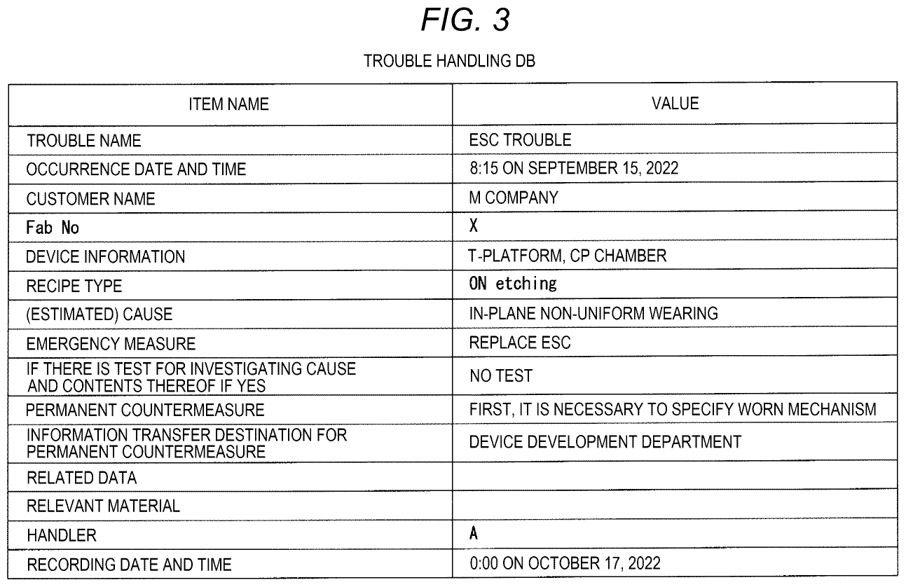

The trouble handling DB 101 is a database that stores various types of information related to how a user handles a trouble in a device such as a substrate processing device or a transfer device. FIG. 3 is a schematic diagram illustrating an example of the trouble handling DB 101. The trouble handling DB 101 is, for example, a database in which values are associated with item names such as “trouble name”, “occurrence date and time”, “customer name”, “Fab No”, “device information”, “recipe type”, “(estimated) cause”, “emergency measure”, “if there is test for investigating cause and contents thereof if yes”, “permanent countermeasure”, “information transfer destination for permanent countermeasure”, “relevant data”, “relevant material”, “handler”, and “recording date and time”.

The item of “trouble name” stores, for example, information “ESC trouble” as a value. The item of “occurrence date and time” stores, for example, information “8:15 on September 15, 2022” as a value. The item of “customer name” stores, for example, information “M company” as a value. The item of “Fab No” stores, for example, information “X” as a value. The item of “device information” stores, for example, information “T-platform, CP chamber” as a value. The item of “recipe type” stores, for example, information “ON etching” as a value. The item of “(estimated) cause” stores, for example, information “in-plane non-uniform wearing” as a value. The item of “emergency measure” stores, for example, information “replace ESC” as a value. The item of “if there is test for investigating cause and contents thereof if yes” stores, for example, information “no test” as a value. The item of “permanent countermeasure” stores, for example, information “first, it is necessary to specify worn mechanism” as a value. The item of “information transfer destination for permanent countermeasure” stores, for example, information “device development department” as a value. Although not illustrated in FIG. 3, the items of “relevant data” and “relevant material” store information such as an address or a link of a location where a file such as relevant data or material is stored. The item of “handler” stores, for example, information “A” as a value. The item of “recording date and time” stores, for example, information “0:00 on Oct. 17, 2022” as a value. The item names and their values are examples and are not limited thereto.

Although the information processing device 1 includes the trouble handling DB 101, the present disclosure is not limited thereto. The trouble handling DB 101 may be provided in a device different from the information processing device 1. In this case, the information processing device 1 communicates with the device provided with the trouble handling DB 101 and reads information from, and writes information into, the trouble handling DB 101.

The communication unit 13 transmits and receives data to and from devices such as the trouble history recording device 3 and the terminal device 5 via a wired or wireless network N. The communication unit 13 communicates with the trouble history recording device 3 so that the information processing device 1 can acquire information stored in the trouble history DB 102 provided in the trouble history recording device 3. The communication unit 13 communicates with the terminal device 5 so that the information processing device 1 can transmit a question message to a user using the terminal device 5, receive an answer message from the user, and the like. The communication unit 13 transmits data supplied from the processor 11 to another device, receives data from another device, and supplies the received data to the processor 11.

The storage 12 may be an external storage device connected to the information processing device 1. The information processing device 1 may be a multi-computer including a plurality of computers, or may be a virtual machine virtually constructed by software. The information processing device 1 is not limited to the configuration described above and may include, for example, a reading unit that reads information stored in a portable recording medium, an input unit that receives an operation input, or a display unit that displays an image.

In the information processing device 1, the processor 11 reads and executes the program 12a stored in the storage 12, thereby implementing a trouble history monitor 11a, a question sentence generator 11b, an answer sentence acquisition unit 11c, an information shaping unit 11d, a DB processor 11e, and the like as software functional units in the processor 11. In the drawing, among the functional units of the processor 11, functional units related to processing for handling information related to a trouble of a device are illustrated, and functional units related to other kinds of processing are omitted.

The trouble history monitor 11a communicates with the trouble history recording device 3 at an appropriate cycle, such as once every several hours or once every several days, through the communication unit 13, and executes processing of monitoring a state of storing (collecting) trouble history information in the trouble history DB 102 of the trouble history recording device 3. The trouble history monitor 11a monitors whether a large number of pieces of trouble history information stored in the trouble history DB 102 include trouble history information in which handling of a trouble occurring in a device is not completed and for which a predetermined period (for example, one month) has elapsed since the last additional recording of trouble history information recorded in time series. When information that satisfies the condition described above is included, the trouble history monitor 11a acquires the trouble history information from the trouble history recording device 3.

The question sentence generator 11b executes processing of generating a question sentence for supplementing insufficient information based on the trouble history information acquired by the trouble history monitor 11a in correspondence with the above-described condition. The question sentence generator 11b uses the large language model 103 stored in the model information storage 12b to generate a question sentence in the natural language for a user. The question sentence generator 11b supplies the trouble history information acquired by the trouble history monitor 11a to the large language model 103 and also supplies a command (prompt) for generating a question sentence for supplementing insufficient information based on this information. The question sentence generator 11b edits or processes, as appropriate, a question sentence output from the large language model 103 and transmits the question sentence (question message) to the terminal device 5 used by one or more users related to the trouble history information.

The answer sentence acquisition unit 11c acquires an answer sentence (answer message) of a user by receiving the answer sentence transmitted from the terminal device 5 in response to the question message transmitted by the question sentence generator 11b to the terminal device 5. When the answer message acquired by the answer sentence acquisition unit 11c is insufficient, the information processing device 1 may repeatedly transmit a question message to a user and acquire an answer message from the user. In this case, in the information processing device 1, the question sentence generator 11b causes the large language model 103 to determine, based on the answer message acquired by the answer sentence acquisition unit 11c, whether an additional question is to be asked, and causes the large language model 103 to generate a question sentence when an additional question is to be asked. An answer obtained from a user with respect to a question sentence does not necessarily have to be a sentence in the natural language. The answer may be, for example, a number indicating which one of a plurality of options is selected for a question sentence in which a plurality of options are presented, or may be a value, a character, or a word that is not a sentence, such as a numerical value for a question sentence asking a user about a setting value of a device.

The information shaping unit 11d executes processing of shaping the information into information in a predetermined format when trouble history information related to a device is obtained or when the trouble history information is obtained through message exchange with a user. The information shaping unit 11d shapes information into a predetermined format using the large language model 103 stored in the model information storage 12b. The information shaping unit 11d inputs, into the large language model 103, information such as the trouble history information acquired by the trouble history monitor 11a from the trouble history DB 102 and a user answer message acquired by the answer sentence acquisition unit 11c, supplies the information to be shaped into a predetermined format, and supplies a command to shape the information into the predetermined format. The information shaping unit 11d acquires the shaped information output from the large language model 103.

The DB processor 11e executes processing such as storing and reading information in and from the trouble handling DB 101. The DB processor 11e stores the information in the predetermined format shaped by the information shaping unit 11d in the trouble handling DB 101. The DB processor 11e communicates with the terminal device 5 of a user via the communication unit 13, receives a request for reading information from the user, reads desired information from the trouble handling DB 101, and transmits the desired information to the terminal device 5. Further, the DB processor 11e receives a request for searching for information from the terminal device 5, searches for information corresponding to a search condition from the information stored in the trouble handling DB 101, and transmits list information such as a trouble name and the occurrence date and time of the corresponding information to the terminal device 5.

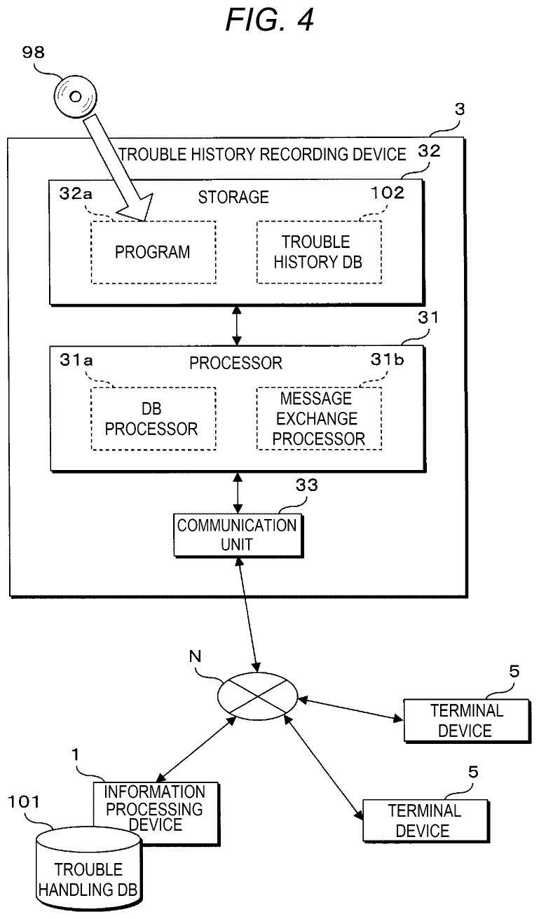

FIG. 4 is a block diagram illustrating a configuration example of the trouble history recording device 3. The trouble history recording device 3 can be implemented by installing a predetermined application program or the like in a general-purpose information processing device such as a personal computer or a server computer. The trouble history recording device 3 includes a processor 31, a storage 32, a communication unit 33, and the like. Although processing is executed by one trouble history recording device 3, the processing of the trouble history recording device 3 may be executed in a distributed manner by a plurality of devices. Further, the information processing device 1 may execute the processing of the trouble history recording device 3. That is, the information processing device 1 and the trouble history recording device 3 may be one device.

The processor 31 is implemented using an arithmetic processing device such as a CPU, an MPU, a GPU, or a quantum processor, together with a ROM, a RAM, and the like. The processor 31 reads and executes a program 32a stored in the storage 32, thereby executing processing such as collection and recording of information related to a history of a trouble. The storage 32 is implemented using, for example, a large-capacity storage device such as a hard disk or an SSD. The storage 32 stores the program 32a to be executed by the processor 31 and is provided with the trouble history DB 102 that stores information related to a history of a trouble. The program (computer program, program product) 32a is provided in a form recorded on a recording medium 98 such as a memory card or an optical disc. The recording medium 98 is a non-transitory, computer-readable recording medium that stores the program 32a in a non-transitory manner. The trouble history recording device 3 reads the program 32a from the recording medium 98 and stores the program 32a in the storage 32. The program 32a may be provided in a distributed manner via a network. The communication unit 33 transmits and receives data to and from a device such as the information processing device 1 and the terminal device 5 via a wired or wireless network N.

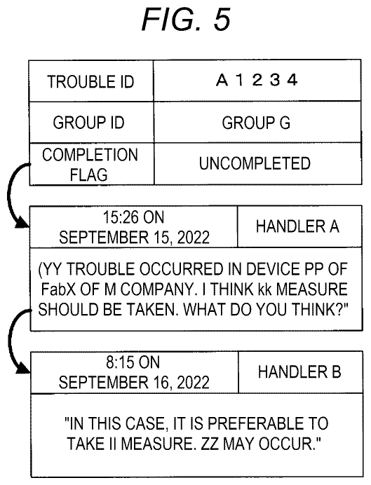

The trouble history DB 102 is a database that stores, as trouble history information, information obtained by one or more users in relation to a history of handling a trouble occurring in a device such as a substrate processing device or a transfer device. FIG. 5 is a schematic diagram illustrating an example of the trouble history information stored in the trouble history DB 102. The trouble history information stored in the trouble history DB 102 is information obtained by connecting, in a time-series order, messages in the natural language exchanged among a group of a plurality of users who handle a trouble in a device such as a substrate processing device or a transfer device. The trouble history recording device 3 receives a message related to trouble handling input by one user through the terminal device 5 and transmits the message to the terminal device 5 of another user of a group to which the one user belongs. At this time, the trouble history recording device 3 stores the message received from the terminal device 5 in the trouble history DB 102 as the trouble history information.

The trouble history information stored in the trouble history DB 102 is information in which one or more pieces of message information are associated, in a time-series order, with header information such as a “trouble ID”, a “group ID”, and a “completion flag”. The “trouble ID” and the “group ID” are each represented by an appropriate character string, and the “completion flag” is binary information that is set to either “completed” or “uncompleted”. In the illustrated example, the “trouble ID” of the header information is “A1234”, the “group ID” is “group G”, and the “completion flag” is “uncompleted”.

The message information associated with the header information may include, for example, information such as a time stamp, a user ID, and a message sentence. In the illustrated example, two pieces of message information are associated with the header information in a time-series order. In the first message information, the time stamp is “15:26 on Sep. 15, 2022”, the user ID is “handler A”, and the message sentence indicates that “a YY trouble occurred in a device PP of FabX of the M Company. I think a kk measure should be taken. What do you think?” In the second message information, the time stamp is “8:15 on Sep. 16, 2022”, the user ID is “handler B”, and the message sentence indicates that “in this case, it is preferable to take a II measure. ZZ may occur”.

A user who first transmits a message about a trouble occurring in a device such as a substrate processing device or a transfer device selects, for example, a group with which the message is to be shared and notifies the trouble history recording device 3, via the terminal device 5, that handling of the trouble has started. When the trouble history recording device 3 receives the notification from the terminal device 5, the trouble history recording device 3 generates a trouble ID, stores header information in the trouble history DB 102, and stores information related to messages subsequently transmitted and received among users in a time-series order in association with the header information. When handling of the trouble is completed, the user notifies the trouble history recording device 3 of the completion of the handling of the trouble via the terminal device 5. When the trouble history recording device 3 receives the notification from the terminal device 5, the trouble history recording device 3 sets the “completion flag” of the header information to “completed”.

Although the trouble history recording device 3 includes the trouble history DB 102, the present disclosure is not limited thereto. The trouble history DB 102 may be provided in a device different from the trouble history recording device 3. In this case, the trouble history recording device 3 communicates with the device provided with the trouble history DB 102 and reads information from, and writes information into, the trouble history DB 102.

Further, the storage 32 may be an external storage device connected to the trouble history recording device 3. The trouble history recording device 3 may be a multi-computer including a plurality of computers, or may be a virtual machine virtually constructed by software. The trouble history recording device 3 is not limited to the configuration described above and may include, for example, a reading unit that reads information stored in a portable recording medium, an input unit that receives an operation input, or a display unit that displays an image.

In the trouble history recording device 3, the processor 31 reads and executes the program 32a stored in the storage 32, thereby implementing a message exchange processor 31a, a DB processor 31b, and the like as software functional units in the processor 31. In the drawing, functional units related to processing for collecting trouble history information are illustrated as functional units of the processor 31, and functional units related to other kinds of processing are omitted.

The message exchange processor 31a communicates with the one or more terminal devices 5 via the communication unit 33 and executes processing related to message exchange among a plurality of users who handle a trouble of a device. The message exchange processor 31a receives a message from one user and transmits the received message to the other users included in a group to which the one user belongs. Information such as users belonging to a group and a destination to which a message is to be sent to each user is registered by a user in advance and is stored as registration information in the storage 32.

The DB processor 31b executes processing of storing, as trouble history information, information related to a message transmitted and received between users by the message exchange processor 31a in the trouble history DB 102. The DB processor 31b receives a message received from a user by the message exchange processor 31a, attaches information such as the date and time when the message was received (time stamp) and an ID of a user who sent the message to a message sentence, and stores the message information in association with the header information in a time-series order. In response to a request from the information processing device 1 or the terminal device 5, the DB processor 31b searches for and extracts information stored in the trouble history DB 102 and transmits result information to a request source. The DB processor 31b can extract, for example, trouble history information in which the “completion flag” is “uncompleted” from the information stored in the trouble history DB 102 and transmit the information to the information processing device 1.

### Trouble Information Processing

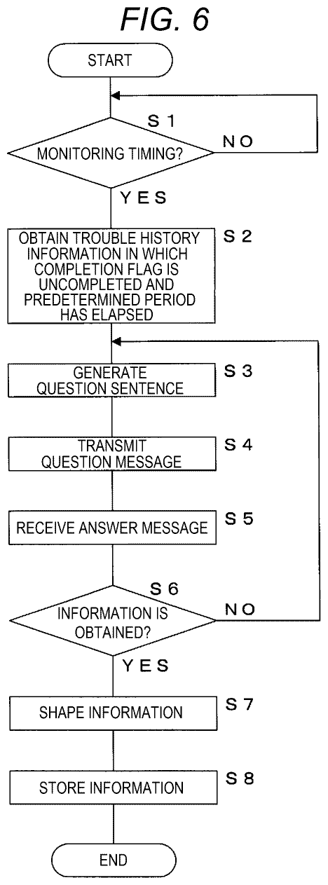

FIG. 6 is a flowchart illustrating an example of a procedure of processing executed by the information processing device 1. The trouble history monitor 11a of the processor 11 of the information processing device 1 monitors information stored in the trouble history DB 102 of the trouble history recording device 3 at a predetermined cycle, for example, once an hour or once a day. The trouble history monitor 11a determines whether a monitoring timing has arrived in accordance with the predetermined cycle (step S1). When the monitoring timing has not arrived (S1: NO), the trouble history monitor 11a stands by until the monitoring timing arrives.

When the monitoring timing has arrived (S1: YES), the trouble history monitor 11a communicates with the trouble history recording device 3 via the communication unit 13 and acquires, from the trouble history DB 102, trouble history information in which the “completion flag” is “uncompleted” and for which a predetermined period (for example, one month) has elapsed since the time stamp of a last message (step S2). The processing of identifying, in the trouble history DB 102, the trouble history information in which the completion flag is uncompleted and for which the predetermined period has elapsed may be executed by the trouble history recording device 3 or directly by the information processing device 1.

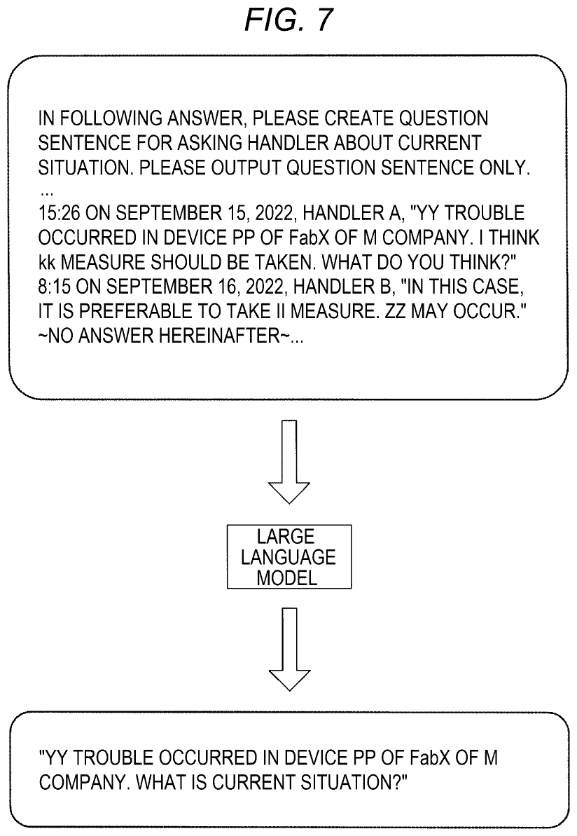

Next, the question sentence generator 11b of the processor 11 generates a question sentence for a user based on the trouble history information in which the completion flag is uncompleted, which is acquired in step S2 (step S3). At this time, the question sentence generator 11b can generate a question sentence by supplying, to the large language model 103 stored in the model information storage 12b, the acquired trouble history information in which the completion flag is uncompleted, together with a command (prompt) for generating a question sentence that asks a user about a subsequent situation or the like. FIGS. 7 to 9 are schematic diagrams illustrating examples of information input to the large language model 103 and information output by the large language model 103.

The example illustrated in FIG. 7 illustrates a case in which a question sentence is generated based on the trouble history information in which the completion flag is uncompleted, as illustrated in FIG. 5. For example, the question sentence generator 11b inputs, to the large language model 103, text information “In the following answer, please create a question sentence for asking a handler about a current situation. Please output the question sentence only. ... 15:26 on Sep. 15, 2022, handler A, “A YY trouble occurs in a device PP of FabX of the M Company. A kk measure should be taken. What do you think?” 8:15 on Sep. 16, 2022, handler B, “In this case, it is preferable to take a II measure. ZZ may occur.” No answer hereinafter.” The first half of this input information, “In the following answer ... Please output the question sentence only.”, is a predetermined fixed sentence, and the second half is text information arranged in time series by expanding a time stamp, a user ID, and message information included in the trouble history information. In response to this input information, the large language model 103 outputs, for example, a question sentence indicating that “A YY trouble occurs in a device PP of FabX of the M Company. What is a current situation?”.

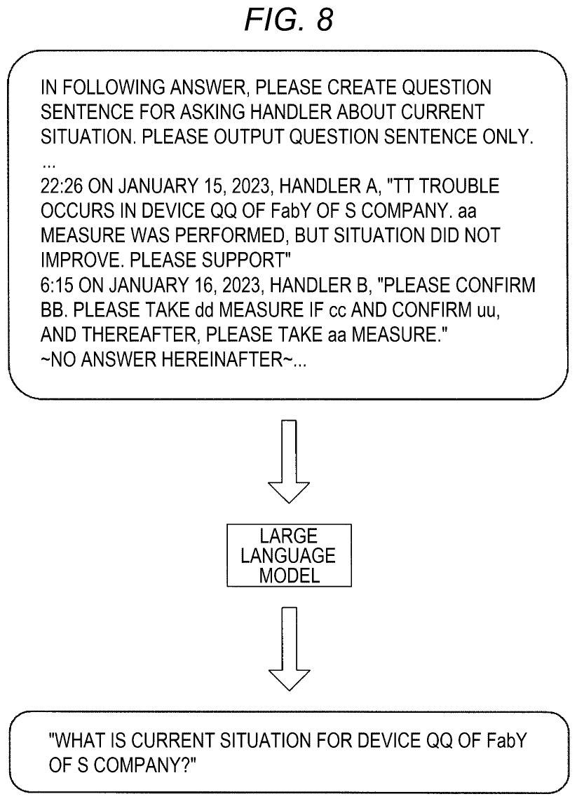

The example illustrated in FIG. 8 illustrates a case in which a question sentence is generated based on trouble history information different from that in FIG. 7. For example, the question sentence generator 11b inputs, to the large language model 103, text information “In the following answer, please create a question sentence for asking a handler about a current situation. Please output the question sentence only ... 22:26 on Jan. 15, 2023, handler A, “A TT trouble occurs in a device QQ of FabY of the S Company. An aa measure was performed, but the situation did not improve. Please support.” 6:15 on Jan. 16, 2023, handler B, “Please confirm BB. Please take a dd measure if cc and confirm uu, and thereafter, please take an aa measure.” No answer hereinafter.” In response to this input information, the large language model 103 outputs, for example, a question sentence indicating “What is a current situation for the device QQ of FabY of the S company?”.

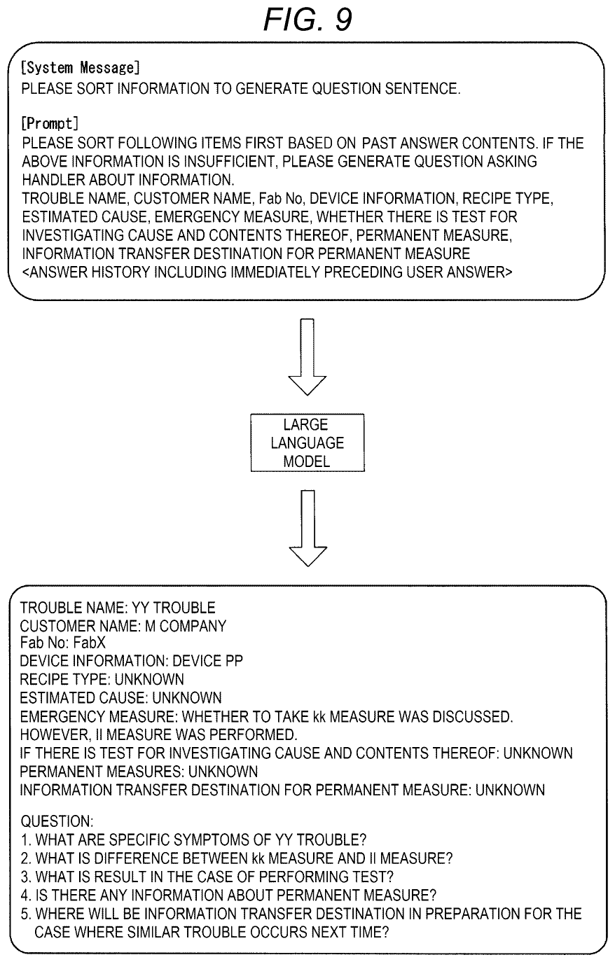

The example illustrated in FIG. 9 illustrates a case in which a question is additionally asked after a user answer to a question is obtained, and an additional question is generated for the user answer to the question illustrated in FIG. 7. For example, the question sentence generator 11b inputs, to the large language model 103, text information “[System Message] Please sort information to generate a question sentence. [Prompt] Please sort the following items first based on past answer contents. If the above information is insufficient, please generate a question asking a handler about the information. A trouble name, a customer name, Fab No, device information, a recipe type, an estimated cause, an emergency measure, whether there is a test for investigating a cause and contents thereof, a permanent countermeasure, an information transfer destination for the permanent countermeasure <answer history including immediately preceding user answer>”. The input information can be obtained, for example, by embedding an answer sentence from an actual user at a location in the <answer history including immediately preceding user answer>with respect to a predetermined fixed sentence.

In response to the input information, the large language model 103 outputs an information sorting result indicating
“Trouble name: YY trouble
Customer name: M company
Fab No: FabX
Device information: Device PP
Recipe type: Unknown
Estimated cause: Unknown
Emergency measure: Whether to take a kk measure was discussed. However, a II measure was performed.
If there is test for investigating cause and contents thereof: Unknown
Permanent countermeasure: Unknown
Information transfer destination for permanent countermeasure: Unknown ”. Further, the large language model 103 outputs question sentences, for example,
“Question:
1. What are specific symptoms of the YY trouble?
2. What is the difference between the kk measure and the II measure?
3. What is the result in the case of performing a test?
4. Is there any information about the permanent countermeasure?
5. Where will be the information transfer destination in preparation for a case where a similar trouble occurs next time?
”.

The question sentence generator 11b that generated these question sentences in step S3 of the flowchart illustrated in FIG. 6 transmits a question message including the generated question sentences to the terminal device 5 used by one or more users included in a group associated with the trouble (step S4). The answer sentence acquisition unit 11c of the processor 11 receives an answer message to the question message transmitted in step S4 from the terminal device 5 (step S5) and acquires an answer sentence of a user. Based on the answer message received in step S5, the answer sentence acquisition unit 11c determines whether the information for storing the answer message in the trouble handling DB 101 has been obtained (step S6). At this time, for example, the answer sentence acquisition unit 11c inputs information similar to that illustrated in FIG. 9 into the large language model 103 and can determine whether the necessary information has been obtained on the condition that an information sorting result output by the large language model 103 does not include “unknown”. When the necessary information has not been obtained (S6: NO), the answer sentence acquisition unit 11c returns the processing to step S3 and repeatedly exchanges a question message and an answer message with the user.

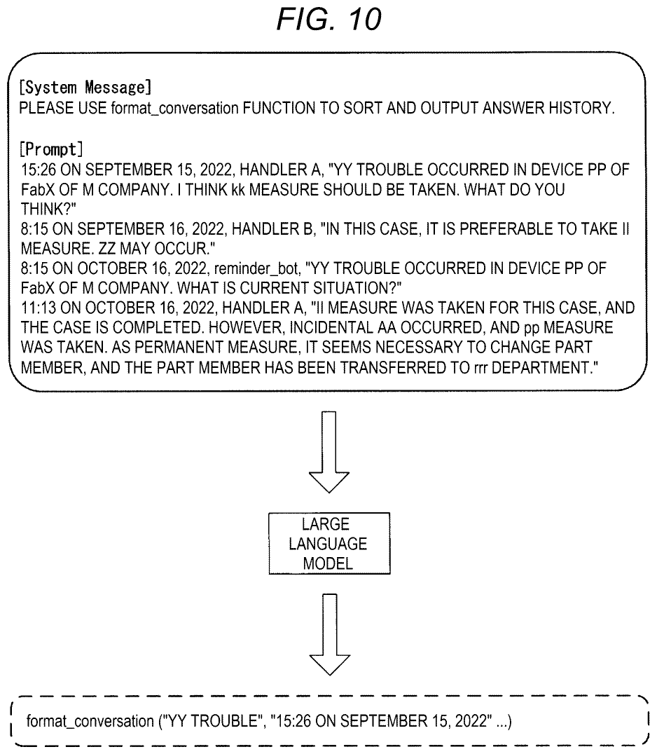

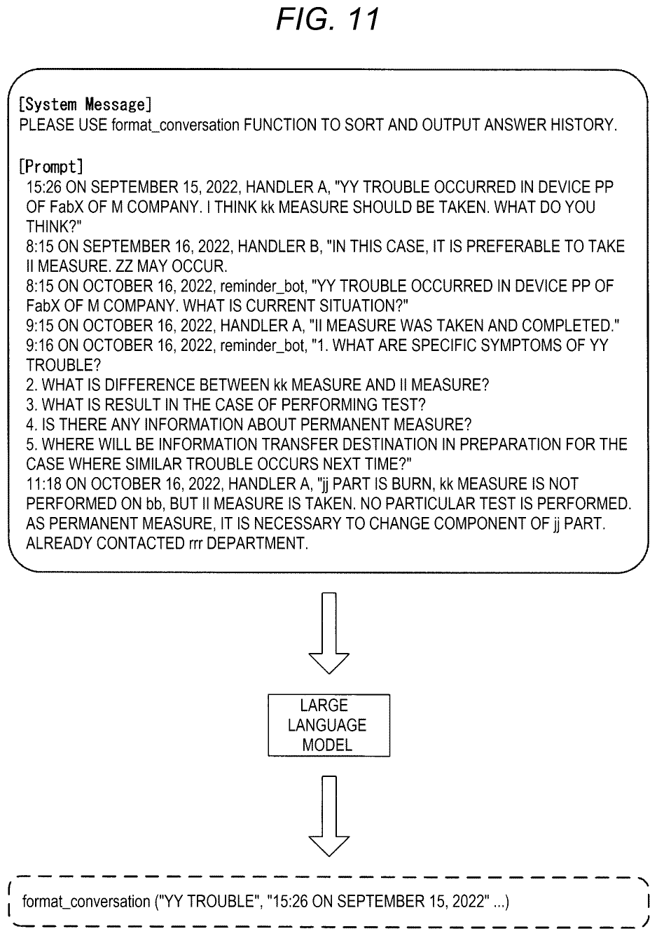

When the necessary information has been obtained (S6: YES), the information shaping unit 11d of the processor 11 shapes the information acquired from the trouble history DB 102 and the information obtained through the message exchange with the user into a predetermined format for storing the information in the trouble handling DB 101 (step S7). At this time, the information shaping unit 11d can shape the information by supplying the information to be shaped to the large language model 103 stored in the model information storage 12b and supplying a command (prompt) for shaping the information into a predetermined format. FIGS. 10 and 11 are schematic diagrams illustrating examples of information input to the large language model 103 and information output by the large language model 103.

The example illustrated in FIG. 10 illustrates a case in which information is shaped when an answer of a user to a question, illustrated in FIG. 7, is received. For example, the information shaping unit 11d inputs, to the large language model 103, the following text information.
[System Message]
Please use the format_conversation function to sort and output an answer history.
[Prompt]
15:26 on Sep. 15, 2022, handler A, “A YY trouble occurs in a device PP of FabX of the M Company. I think a kk measure should be taken. What do you think?”
8:15 on Sep. 16, 2022, handler B “in this case, it is preferable to take a II measure. ZZ may occur.”
8:15 on Oct. 16, 2022, reminder_bot “A YY trouble occurred in a device PP of FabX of the M Company. What is the current situation?”
11:13 on Oct. 16, 2022, handler A “A II measure was taken for this case, and the case is completed. However, an incidental AA occurred, and a pp measure was taken. As a permanent countermeasure, it seems necessary to change a part member, and the part member has been transferred to an m department.”

The information processing device 1 executes the format_conversation function prepared in advance, so that information can be stored in the trouble handling DB 101 in a predetermined format. The format_conversation function receives, for example, a value corresponding to an item name illustrated in FIG. 3 as an argument and stores the received value in a corresponding location in the trouble handling DB 101. For example, the order of a plurality of arguments is predetermined, such as format_conversation (trouble name, occurrence date and time ... recording date and time), and specification information of the function is given in advance to the large language model 103. The large language model 103 extracts information given as an argument to the format_conversation function by sorting and summarizing input information in the natural language and outputs text information in which an argument is set to the format_conversation function, such as “format_conversation (“YY trouble”, “15:26 on Sep. 15, 2022 ...)” in the present example. The information processing device 1 can acquire text information about a function call obtained from the large language model 103 as an information shaping result and can store the information in a predetermined format in the trouble handling DB 101 by executing the function.

The example illustrated in FIG. 11 illustrates a case in which shaping is performed on information obtained through a plurality of questions and answers illustrated in FIG. 9. For example, the information shaping unit 11d inputs, to the large language model 103, the following text information.
[System Message]
Please use the format_conversation function to sort and output an answer history.
[Prompt]
15:26 on Sep. 15, 2022, handler A, “A YY trouble occurs in a device PP of FabX of the M Company. I think a kk measure should be taken. What do you think?”
8:15 on Sep. 16, 2022, handler B “In this case, it is preferable to take a II measure. ZZ may occur.”
8:15 on Oct. 16, 2022, reminder_bot “A YY trouble occurred in a device PP of FabX of the M Company. What is the current situation?”
9:15 on Oct. 16, 2022, handler A “The II measure was taken and completed.”
9:16 on Oct. 16, 2022, reminder_bot, “1. What are specific symptoms of the YY trouble? 2. What is the difference between the kk measure and the II measure? 3. What is the result in the case of performing a test? 4. Is there any information about the permanent countermeasure? 5. Where will be the information transfer destination in preparation for a case where a similar trouble occurs next time?”
11:18 on Oct. 16, 2022, handler A “the jj part is burnt, the kk measure is not performed on bb, but the II measure is taken. No particular test is performed. As a permanent countermeasure, it is necessary to change the component of the jj part. Already contacted an rrr department.”

In response to this input, the large language model 103 outputs text information in which an argument is set to the format_conversation function, such as “format_conversation (“YY trouble”, “15:26 on Sep. 15, 2022”...)”.

After the information is shaped in step S7 of the flowchart illustrated in FIG. 6, the DB processor 11e of the processor 11 stores the shaped information in the predetermined format in the trouble handling DB 101 (step S8) and ends the processing. At this time, the DB processor 11e can store the information in the predetermined format in the trouble handling DB 101 by executing the format_conversation function based on the information about the function call obtained from the large language model 103 in step S7.

In the information processing system, for example, a user who wants to obtain existing knowledge related to trouble handling can access the information processing device 1 using the terminal device 5 and search for and browse information stored in the trouble handling DB 101. For example, the user inputs a name, a cause, or a device name related to a trouble into the terminal device 5 based on a condition and searches the information stored in the trouble handling DB 101. The terminal device 5 transmits the input search condition and an information search request based on the search condition to the information processing device 1. The information processing device 1 extracts information corresponding to the search condition from the trouble handling DB 101 in response to a request from the terminal device 5 and transmits the extracted information, summary information of the extracted information, or the like to the requesting terminal device 5 as a search result. The terminal device 5 receives the search result information from the information processing device 1 and displays the received information on a display.

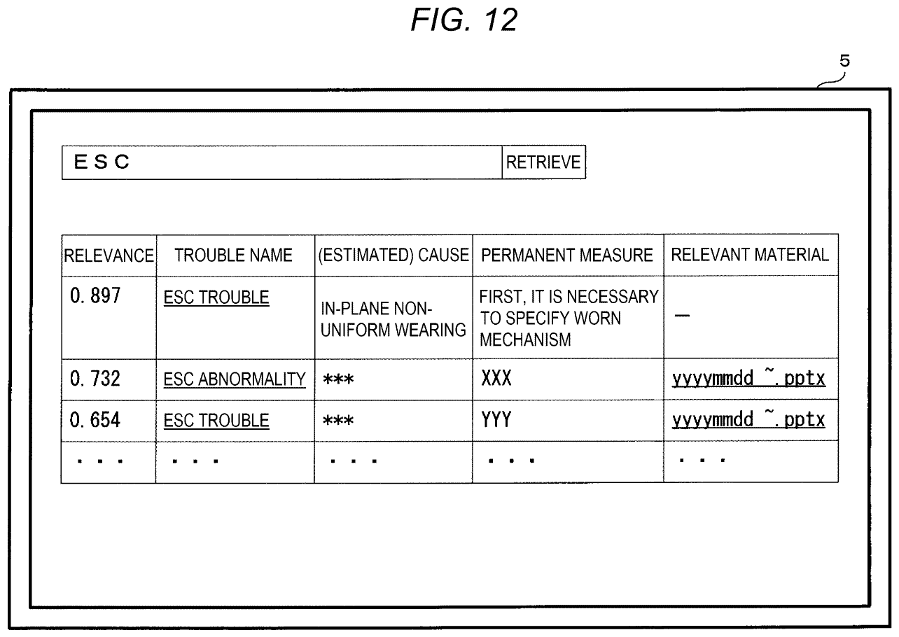

FIG. 12 is a schematic diagram illustrating an example of information displayed by the terminal device 5. The terminal device 5 displays an input box for inputting a word, a sentence, or the like as a search condition, and a search button for receiving a search execution instruction, side by side on the display, and receives a search operation for information related to trouble handling from a user. The terminal device 5 displays a list of search results in a table format based on information obtained as responses to the search request from the information processing device 1. The example illustrated in FIG. 12 lists search results when a term “ESC” is designated as a search condition.

In the present example, the terminal device 5 displays a list of items such as “relevance”, “trouble name”, “(estimated) cause”, “permanent countermeasure”, and “relevant material” as information related to the trouble handling that satisfies the search condition, and presents the search result to a user. Among these items, “relevance”, for example, is a numerical value obtained by converting a word, a sentence, or the like input as a search condition, and information related to trouble handling corresponding to the search condition, into respective feature value vectors using a prepared encoder, and calculating a similarity (for example, cosine similarity) between two vectors. The terminal device 5 displays a list of a plurality of pieces of information arranged in an up-down direction in descending order of the relevance. The four items of “trouble name” to “relevant material” are items included in the information stored in the trouble handling DB 101, and the terminal device 5 can extract some or all of the information from corresponding items and display the extracted information in the table.

In the present example, a search result indicates that information such as “ESC trouble” and “ESC abnormality” is stored in the trouble handling DB 101 as the “trouble name” in response to the search condition “ESC”. For example, the “ESC trouble” with the highest “relevance” of “0.897” indicates that the “(estimated) cause” is “in-plane non-uniform wearing” and that the “permanent countermeasure” is “first, it is necessary to specify the worn mechanism”. The user selects any one of the plurality of pieces of information displayed in the list, and details of the information are displayed on the terminal device 5 by performing, for example, a click operation or a touch operation on the selected trouble name (not illustrated).

### Operation and Effects

In the information processing system configured as described above, the information processing device 1 acquires, from the trouble history recording device 3, trouble history information related to a history of handling an event occurring in a device such as a substrate processing device or a transfer device. The information processing device 1 generates a question sentence in the natural language related to the acquired trouble history information by using the large language model 103 and outputs the generated question sentence to the terminal device 5 of a user. The information processing device 1 acquires a user answer to the question sentence from the terminal device 5 and stores information related to the acquired answer in the trouble handling DB 101. In this manner, the information processing system collects and stores information related to an event occurring in a device.

In the information processing system, the information processing device 1 acquires, from the trouble history DB 102 that stores information related to a trouble history, information for which handling of a trouble is not completed, and generates a question sentence related to a current state of the trouble. In this manner, the information processing system collects information related to a trouble for which handling is not completed.

In the information processing system, the information processing device 1 shapes an answer sentence acquired from a user into information in a predetermined format by using the large language model 103 and stores the shaped information in the trouble handling DB 101. In this manner, the information processing system receives an answer sentence in the natural language from the user and shapes and stores the received answer sentence in a format suitable for a database.

In the information processing system, when information for shaping the answer sentence acquired from the user into the information in a predetermined format is insufficient, the information processing device 1 generates a question sentence related to the insufficient information, transmits the generated question sentence to the terminal device 5 to present the question sentence to the user, and acquires a user answer to the question sentence. In this manner, the information processing system collects information to be stored in a database without omission.

The examples disclosed herein are exemplary in all respects and should be considered to be non-restrictive. The scope of the present disclosure is defined by the claims rather than by the foregoing description and is intended to include all modifications within the meaning and scope equivalent to the claims.

The features described above can be combined with one another.

1. A non-transitory computer-readable medium storing computer executable instructions which, when executed by a computer, cause the computer to execute a process comprising:
acquiring, from a history database storing information related to a history of handling an event occurring in a device, information indicating that handling of the event is not completed;
generating, using a language model, a question sentence in a natural language related to the acquired information indicating that the handling of the event is not completed;
outputting the generated question sentence;
acquiring an answer to the question sentence; and
storing information related to the acquired answer in an answer database.

2. The non-transitory computer-readable medium according to claim 1, wherein
the information related to the history of handling the event occurring in the device includes a perspective of one or more persons related to a state of the device.

3. The non-transitory computer-readable medium according to claim 1, wherein
the question sentence is generated to ask about a current situation related to handling of the event, for the acquired information indicating that the handling of the event is not completed.

4. The non-transitory computer-readable medium according to claim 1, wherein
the generating of the question sentence and the storing of the information related to the answer are repeatedly performed until the handling of the event is completed.

5. The non-transitory computer-readable medium according to claim 1, wherein
the acquired answer is shaped into information in a predetermined format by the language model, and
the shaped information is stored in the answer database.

6. The non-transitory computer-readable medium according to claim 5, wherein
when information for shaping the acquired answer into the information in the predetermined format is insufficient, a question sentence in the natural language related to the insufficient information is generated,
the generated question sentence is output, and
an answer to the question sentence is acquired.

7. The non-transitory computer-readable medium according to claim 5, wherein
information for executing a function for storing the information in the predetermined format in the answer database is generated by the language model, and
the function is executed based on the generated information, and the information shaped into the predetermined format is stored in the answer database.

8. The non-transitory computer-readable medium according to claim 1, wherein
information related to a history of handling a trouble occurring in a substrate processing device is acquired.

9. The non-transitory computer-readable medium according to claim 1, wherein
a condition for searching for information stored in the answer database is received, and
information corresponding to the received condition is extracted from the answer database and the extracted information is output.

10. An information processing method executed by an information processing device, the information processing method comprising:
acquiring, from a history database storing information related to a history of handling an event occurring in a device, information indicating that handling of the event is not completed;
generating, using a language model, a question sentence in a natural language related to the acquired information indicating that the handling of the event is not completed;
outputting the generated question sentence;
acquiring an answer to the question sentence; and
storing information related to the acquired answer in an answer database.

11. An information processing device comprising
processing circuitry configured to:
acquire, from a history database storing information related to a history of handling an event occurring in a device, information indicating that handling of the event is not completed;
generate, using a language model, a question sentence in a natural language related to the acquired information indicating that the handling of the event is not completed;
output the generated question sentence;
acquire an answer to the question sentence; and
store information related to the acquired answer in an answer database.

12. An information processing system comprising:
the information processing device according to claim 11;
the history database; and
the answer database.

13. The information processing device according to claim 11, wherein the processing circuitry is further configured to
monitor the history database at a predetermined cycle, and
acquire, from the history database, the information indicating that handling of the event is not completed when a predetermined period has elapsed since a last recording of the information related to the history.

14. The information processing device according to claim 11, wherein
the information indicating that handling of the event is not completed is information for which a completion flag associated with the history indicates that handling is not completed and for which a predetermined period has elapsed since a time stamp of a last message of the history.

15. The information processing device according to claim 11, wherein
the information related to the history of handling the event includes a plurality of messages in the natural language exchanged among a plurality of users and associated with one another in a time-series order.

16. The information processing device according to claim 11, wherein
the generated question sentence presents a plurality of options, and
the acquired answer includes information indicating a selected one of the plurality of options.

17. The information processing device according to claim 11, wherein the processing circuitry is further configured to
input the acquired answer into the language model to obtain an information sorting result,
determine whether the information sorting result includes an item for which information has not been obtained, and
generate an additional question sentence related to the item when the information sorting result includes the item for which information has not been obtained.

18. The information processing device according to claim 11, wherein
the language model is stored in a device different from the information processing device, and
the processing circuitry is further configured to acquire, from the different device, a processing result generated by the different device using the language model.

19. The information processing device according to claim 11, wherein
the answer database stores a value of the information related to the acquired answer in association with each of a plurality of predetermined item names, the plurality of predetermined item names including at least a name of the event, a cause of the event, and a countermeasure for the event.

20. The information processing device according to claim 11, wherein the processing circuitry is further configured to
receive a search condition,
convert the search condition and the information stored in the answer database into respective feature value vectors using an encoder,
calculate a relevance based on a similarity between the feature value vectors, and
output a plurality of pieces of the information stored in the answer database in descending order of the relevance.
